(19) United States
(12) Patent Application Publication
(10) Pub. No.: US 2009/0015406 A1
(43) Pub. Date: Jan. 15, 2009

(54) Television Or Other Display Device With Embedded RFID Reader For Managing Media Collections

(75) Inventor: Lisa Anne SEACAT, San Francisco, CA (US)

Correspondence Address: IBM ST-SVL;SAWYER LAW GROUP LLP, 2465 E. Bayshore Road, Suite No. 406, PALO ALTO, CA, 94303, US

(73) Assignee: International Business Machines Corporation, Armonk, NY (US)

(21) Appl. No.: 11/776,513

(22) Filed: Jul. 11, 2007

(51) Int. Cl. G08B 13/14

(52) U.S. Cl. 340/572.1

(57) ABSTRACT

A method and system in accordance with the present invention enables the user to access and locate specific media items such as CDs and DVDs quickly and easily, even if there are large number of them located in one space, and they appear to be very disorganized. Additionally, it gives the user the capability of not only locating specific media items, but also instantly viewing information about them, such as title, genre, performer, date of performance, for example, and even to access and link this information with Internet search and sale-type programs.

### FIELD OF THE INVENTION

The present invention relates generally to RFID technology and more specifically to RFID readers.

### BACKGROUND OF THE INVENTION

People today often have hundreds of DVDs and CDs, or other media items such as magazines, located in their house, apartment or living space. Frequently the DVDs and CDs are not organized according to any particular system, but rather are left in various locations in a disorganized fashion. The result is that it can be very difficult to locate a specific DVD or CD in the collection. Manually searching through a large number of DVDs or CDs is tedious, takes up much time, and can still result in the desired DVD or CD not being found.

What is needed is a method and system to facilitate locating a specific DVD, CD or other kind of media item from within a large, often disorganized collection of DVDs, CDs and other media items, in a way that is quick, inexpensive and accurate. The present invention meets such a need.

### SUMMARY OF THE INVENTION

A method and system in accordance with the present invention enables the user to access and locate specific media items such as CDs and DVDs quickly and easily, even if there are large number of them located in one space, and they appear to be very disorganized. Additionally, it gives the user the capability of not only locating specific media items, but also instantly viewing information about them, such as title, genre, performer, date of performance, for example, and even to access and link this information with internet search and sale-type programs.

### BRIEF DESCRIPTION OF THE DRAWINGS

FIG. 1 shows a media display device, a collection of media items and an RFID reader and tags placed on the media items.

FIG. 2 shows a typical menu which is displayed when the user activates the media display device containing the RFID reader.

FIG. 3 is a flow chart which illustrates the process in accordance with the present invention.

### DETAILED DESCRIPTION

The present invention relates generally to RFID technology and more specifically to RFID readers. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The system and method in accordance with the present invention allows for a person or organization to organize all of their media collection in a menu form such that a specific DVD, CD or other media item can be easily and quickly located.

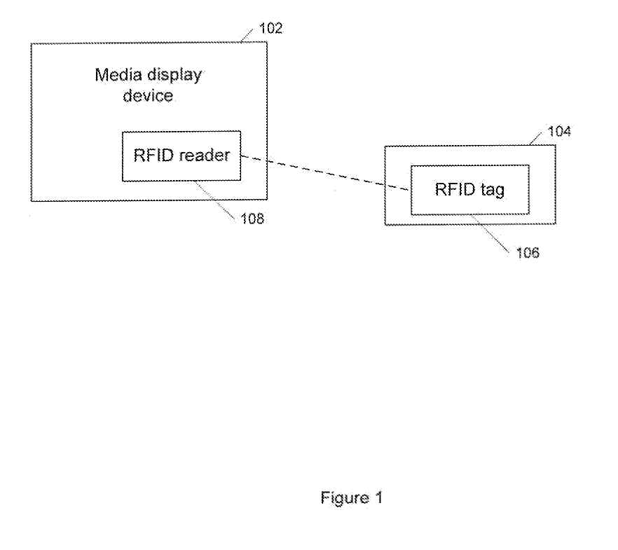

FIG. 1 shows a media display device 102, which can be either a television, home media center, CD player, DVD player, or other kind of device utilized for displaying information from media, such as a computer, PDA or handheld player such as an iPod. Also shown is a collection of CDs, DVDs and related kinds of media 104 located in the same space as the media display device 102. The media 104 could include non-electronic media such as magazines, books, and similar articles. In a first embodiment of the present invention, Radio frequency identification (RFID) tags 106 are placed either on the individual media items within the collection 104 and/or on the containers of the separate media items. An RFID reader 108 is embedded inside the media display device 102.

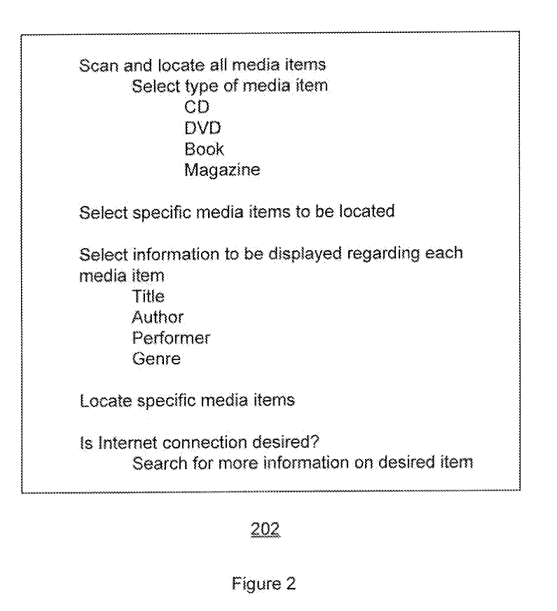

FIG. 2 shows a typical menu 202 which is displayed when the user activates the media display device 102 containing the RFID reader 108. When the user opens the menu 202, the RFID reader 106 scans the surrounding space and the menu 202 indicates which media has been located within the surrounding space.

In a second embodiment of the present invention, the RFID reader 106 could be connected with a network, such as the Internet, so that the user could retrieve information on the available media at a remote location. The menu 202 could sort information on available media according to a plurality of different choices, such as genre, performer, title, and the like.

Once the menu information is connected with the internet and with internet search engines, the user could request reviews of specific media items, or, for example, offer selected media items for sale on the internet.

In a third embodiment of the present invention, a small light bulb or LED might be implanted with the RFID tag on media items in the collection 104. When the user requests, via the menu 202, the location of a particular media item within the collection 104, an LED or similar light, for example, could light up, guiding the user to the exact location of the media item being searched for.

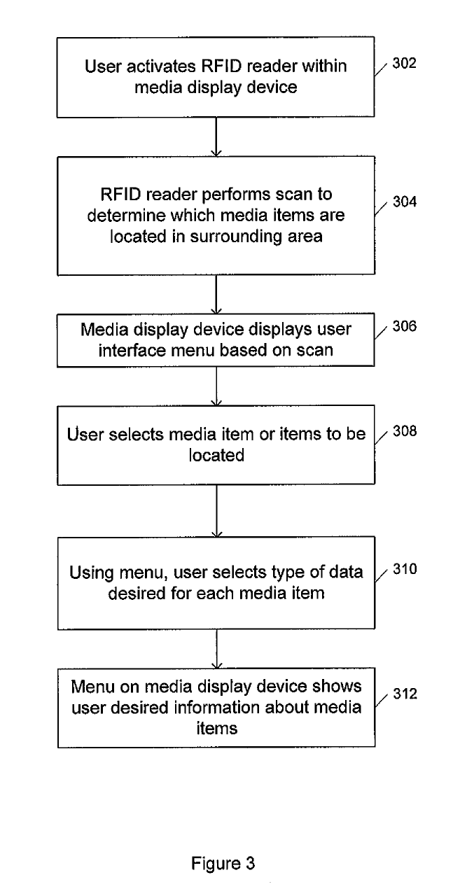

FIG. 3 is a flow chart which illustrates the process in accordance with the present invention. First, the user activates the RFID reader embedded inside the media display device, via step 302. Next, the RFID reader embedded into the media display device performs a quick scan to determine which media items are located in the surrounding space, via step 304. Then, the RFID reader displays an easy-to-comprehend user interface menu on the media display device which provides information to the user about the available media with choices as to performer, title, etc., via step 306. Next, using the menu, the user selects the media item or items to be located, via step 308. Then, using the menu, the user selects the type of data which is desired for each media item, via step 310. Finally, the menu on the media display device shows the user the desired information about available media items, via step 312.

### Advantages

A method and system in accordance with the present invention enables the user to access and locate specific media items such as CDs and DVDs quickly and easily, even if there are large number of them located in one space, and they appear to be very disorganized. Additionally, it gives the user the capability of not only locating specific media items, but also instantly viewing information about them, such as title, genre, performer, date of performance, for example, and even to access and link this information with internet search and sale-type programs.

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method for managing a media collection, the method:
providing an RFID tag on each media item of the media collection within a specified area;
activating an RFID reader in a media display device in the specified area;
scanning by the RFID reader for the RFID tags on each media item to determine which media items are located in the specified area;
displaying a user interface on the media display device which displays the media items based upon the scan;
selecting media items to be located using the user interface;
selecting type of data desired for each media item to be located using the user interface; and
utilizing a menu provided by a user interface to show the user the desired information about the media items based upon the associated RFID tags.

2. The method of claim 1 wherein the media items can be any of or any combination of compact disks (CDs), digital video disks, books and magazines.

3. The method of claim 1 wherein the RFID reader is coupled to a network.

4. The method of claim 1 wherein a light is implanted within each of the RFID tags to provide an indication of the location of the media item.

5. The method of claim 3 wherein information about the media items can be viewed wherein the information comprises title, date of performance, performer or genre.

6. The method of claim 3 wherein information about the media items can be utilized to link with an internet search and/or sales-type program.

7. A system for managing a media collection; the system comprising:
a plurality of media items within a specified location, the media items including an RFID tag thereon; and
a display device, the display device including an RFID reader, wherein the RFID reader scans for the RFID tags on each media item to determine which media items are located in the specified area; wherein a user interface on the display device displays the media items based upon the scan; wherein media items to be located are selected using the user interface; wherein the type of data desired for each media item to be located is selected using the user interface; and wherein a menu provided by a user interface is utilized to show the user the desired information about the media items based upon the associated RFID tags.

8. The system of claim 7 wherein the display device comprises any of a television, home media player, CD player and DVD player.

9. The system of claim 8 wherein the media items can be any of or any combination of compact disks (CDs), digital video disks, books and magazines.

10. The system of claim 7 wherein the RFID reader is coupled to a network.

11. The system of claim 7 wherein a light is implanted within each of the RFID tags to provide an indication of the location of the media item.

12. The system of claim 10 wherein information about the media items can be viewed wherein the information comprises title, date of performance, performer or genre.

13. The system of claim 10 wherein information about the media items can be utilized to link with an internet search and/or sales-type program.
